(19) United States
(12) Patent Application Publication
(10) Pub. No.: US 2023/0358862 A1
(43) Pub. Date: Nov. 9, 2023

(54) LINE BEAM SCANNING OPTICAL SYSTEM AND LASER RADAR

(71) Applicant: Panasonic Intellectual Property Management Co., Ltd., Osaka (JP)

(72) Inventor: Kimihiro MURAKAMI, Osaka (JP)

(21) Appl. No.: 18/222,100

(22) Filed: Jul. 14, 2023

Related U.S. Application Data
(63) Continuation of application No. PCT/JP2021/048374, filed on Dec. 24, 2021.

(30) Foreign Application Priority Data
Jan. 18, 2021 (JP) 2021-005766

(51) Int. Cl. G01S 7/481; G01S 7/484

(52) U.S. Cl. CPC G01S 7/4817; G01S 7/484; G01S 7/4815

(57) ABSTRACT

A line beam scanning optical system includes: at least one laser light source; a light deflector having a mirror; a lens configured to condense laser light at least in a long side direction of a line beam and cause the laser light to be incident on the mirror; and a light guide that is placed between the laser light source and the lens and on which the laser light emitted from the laser light source is incident. The light guide has two surfaces opposing each other in a long side direction of the line beam, reflects the laser light at the two surfaces to confine the laser light inside the light guide, and causes the mixed laser light to be incident on the lens.

### CROSS REFERENCE TO RELATED APPLICATION

This application is a continuation of International Application No. PCT/JP2021/048374 filed on Dec. 24, 2021, entitled “LINE BEAM SCANNING OPTICAL SYSTEM AND LASER RADAR”, which claims priority under 35 U.S.C. Section 119 of Japanese Patent Application No. 2021-005766 filed on Jan. 18, 2021, entitled “LINE BEAM SCANNING OPTICAL SYSTEM AND LASER RADAR”. The disclosures of the above applications are incorporated herein by reference.

### BACKGROUND OF THE INVENTION

### Field of the Invention

The present invention relates to a line beam scanning optical system for performing scanning with a line beam, and a laser radar for detecting an object by using the line beam scanning optical system.

### Description of Related Art

To date, laser radars that detect objects using laser light have been developed in various fields. For example, in a vehicle-mounted laser radar, laser light is projected from the front of the vehicle, and whether or not an object such as a vehicle exists in front of the vehicle is determined on the basis of the presence/absence of reflected light of the laser light. Moreover, the distance to the object is measured on the basis of the projection timing of the laser light and the reception timing of the reflected light.

International Publication No. 2020/137079 discloses a laser radar for detecting an obstacle in front of a vehicle by performing scanning with a linear beam in a short side direction thereof. In this laser radar, a plurality of laser light sources are aligned in a straight line, thereby increasing the radiation energy of the line beam. Each laser light emitted from the plurality of laser light sources is converted by a first cylindrical lens into collimated light in a direction perpendicular to the direction in which the laser light sources are aligned, and is further condensed on a mirror of a light deflector by a second cylindrical lens. The laser light reflected by the mirror spreads in the direction in which the laser light sources are aligned. Accordingly, a line beam spreading in a long side direction is formed.

In the above configuration, as the number of laser light sources aligned in a straight line is increased, or as the intervals between the plurality of light sources are widened, the incident region of the laser light on the second cylindrical lens can be widened, and the spread angle of the line beam can be widened by causing an outer peripheral region of the second cylindrical lens, that is distant from the optical axis thereof and in which the refractive power is high, to act on the laser light. On the other hand, from the viewpoint of simplifying and downsizing the configuration, reducing the cost, etc., the laser radar may be required to reduce the number of laser light sources or narrow the intervals between the plurality of light sources. In addition, in order to properly and reliably detect objects that are equidistant from the light sources in the entire range of scanning with the line beam, it is desirable for the light intensity of the line beam to be uniform in the long side direction of the line beam.

### SUMMARY OF THE INVENTION

A first aspect of the present invention is directed to a line beam scanning optical system for generating a line beam that is long in one direction and performing scanning with the line beam in a short side direction of the line beam. The line beam scanning optical system according to this aspect includes: at least one laser light source; a light deflector having a mirror configured to deflect the line beam in the short side direction; a lens configured to condense laser light emitted from the laser light source, at least in a long side direction of the line beam, and cause the laser light to be incident on the mirror; and a light guide that is placed between the laser light source and the lens and on which the laser light emitted from the laser light source is incident. The light guide has two surfaces opposing each other in the long side direction of the line beam, reflects the laser light at the two surfaces to confine the laser light inside the light guide, and causes the mixed laser light to be incident on the lens.

In the line beam scanning optical system according to this aspect, the beam width of the laser light emitted from the laser light source is widened in the long side direction of the line beam by the light guide, and the laser light is incident on the lens. Accordingly, the laser light is condensed in the long side direction at a large condensing angle and is incident on the mirror, so that the spread angle of the laser light reflected by the mirror can be widened. In addition, the laser light is mixed by repeated reflection on the surfaces of the light guide which oppose each other, and the intensity distribution of the laser light in the long side direction is made uniform. Therefore, in the line beam scanning optical system according to this aspect, widening the angle of the line beam and making the radiation intensity distribution of the line beam uniform can be simultaneously achieved even in the case where the number of laser light sources to be arranged is small.

A second aspect of the present invention is directed to a laser radar. The laser radar according to this aspect includes the line beam scanning optical system according to the first aspect and a light receiving optical system configured to receive reflected light, from an object, of laser light projected from the line beam scanning optical system.

Since the laser radar according to this aspect includes the line beam scanning optical system according to the first aspect, widening the angle of the line beam and making the radiation intensity distribution of the line beam uniform can be simultaneously achieved even in the case where the number of laser light sources to be arranged is reduced.

The effects and the significance of the present invention will be further clarified by the description of the embodiment below. However, the embodiment below is merely an example for implementing the present invention. The present invention is not limited to the description of the embodiment below in any way.

### BRIEF DESCRIPTION OF THE DRAWINGS

FIG. 1 is a diagram showing configurations of an optical system and a circuitry of a laser radar according to an embodiment;

FIG. 2 is a perspective view showing a configuration of a line beam scanning optical system according to the embodiment;

FIG. 3A and FIG. 3B are each a perspective view showing a configuration of a laser light source according to the embodiment;

FIG. 3C is a perspective view showing a configuration of a light source array of the laser radar according to the embodiment;

FIG. 4A and FIG. 4B are respectively a top view and a front view schematically showing a configuration of a diffusion optical element according to the embodiment;

FIG. 5 is a diagram schematically showing a laser light emission state of the laser radar and a state of a line beam in a target region according to the embodiment;

FIG. 6A and FIG. 6B are each a diagram schematically showing the action of a light guide according to the embodiment;

FIG. 7 is a perspective view showing a configuration of a line beam scanning optical system according to Modification 1;

FIG. 8A and FIG. 8B are respectively a side view and a plan view showing a configuration of a line beam scanning optical system according to Modification 1;

FIG. 9A and FIG. 9B are respectively a side view and a plan view showing a configuration of a line beam scanning optical system according to Modification 2;

FIG. 10A and FIG. 10B are each a side view showing a configuration example of a line beam scanning optical system according to Modification 3;

FIG. 11A and FIG. 11B are respectively a plan view and a side view showing a configuration of a line beam scanning optical system according to Modification 4; and

FIG. 12A and FIG. 12B are respectively a plan view and a side view showing a configuration of a line beam scanning optical system according to Modification 5.

It should be noted that the drawings are solely for description and do not limit the scope of the present invention by any degree.

### DETAILED DESCRIPTION

Hereinafter, an embodiment of the present invention will be described with reference to the drawings. For convenience, in each drawing, X, Y, and Z axes that are orthogonal to each other are additionally shown. The X-axis direction and the Y-axis direction are the long side direction and the short side direction of a line beam projected from the line beam scanning optical system, respectively, and the Z-axis positive direction is a projection direction in which the line beam is projected.

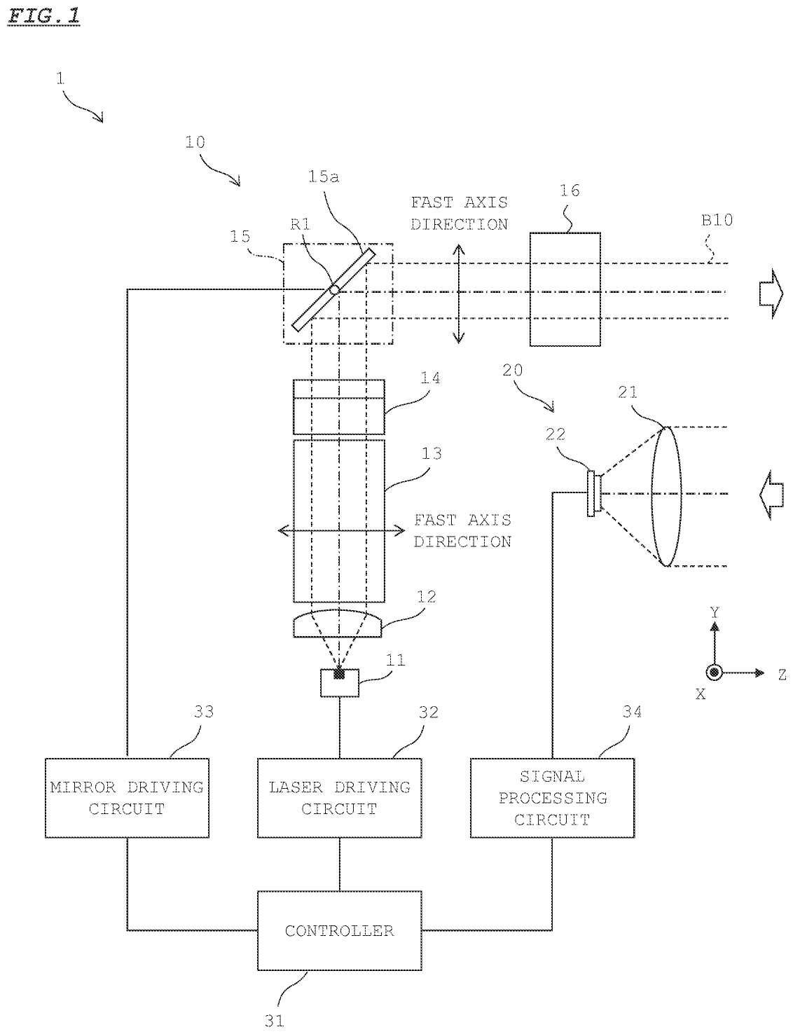

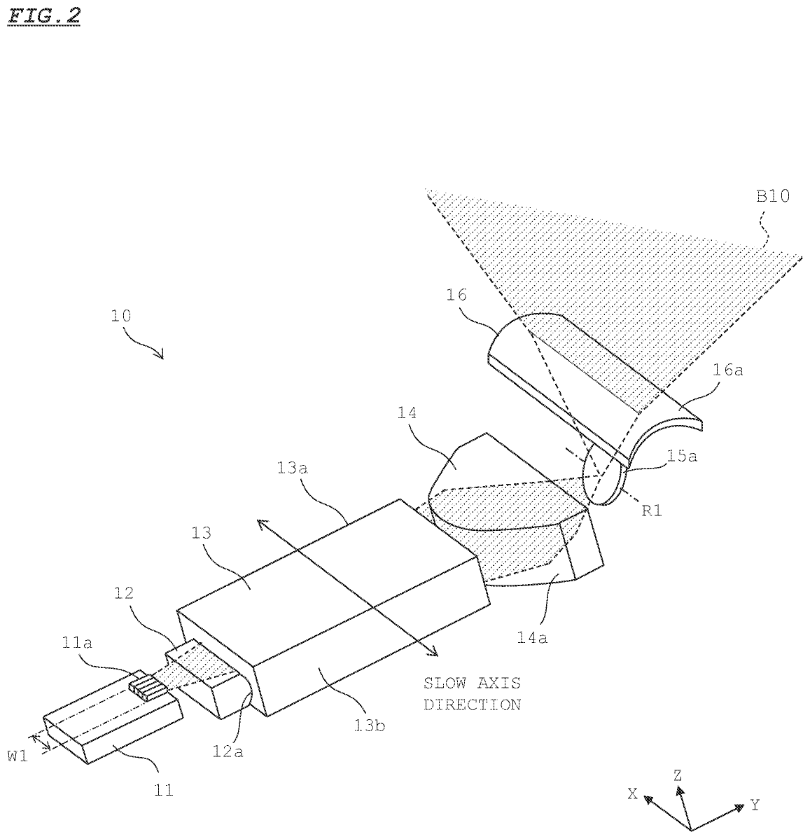

FIG. 1 is a diagram showing configurations of an optical system and a circuitry of a laser radar 1. FIG. 2 is a perspective view showing a configuration of a line beam scanning optical system 10.

As shown in FIG. 1, the laser radar 1 includes the line beam scanning optical system 10 and a light receiving optical system 20 as components of the optical system thereof. The line beam scanning optical system 10 generates a line beam B10 that is long in one direction (X-axis direction), and performs scanning with the line beam B10 in the short side direction thereof (Y-axis direction). The light receiving optical system 20 receives reflected light, from an object, of laser light projected from the line beam scanning optical system 10.

The line beam scanning optical system 10 includes a light source array 11, a fast axis cylindrical lens 12, a light guide 13, a slow axis cylindrical lens 14, a light deflector 15, and a diffusion optical element 16. In addition, the light receiving optical system 20 includes a light receiving lens 21 and a light receiving element 22.

The light source array 11 is configured by integrating a plurality of laser light sources 11a. For example, in the light source array 11, four laser light sources 11a are arranged so as to be aligned in a direction corresponding to the long side direction of the line beam B10. Each laser light source 11a emits laser light having a predetermined wavelength. The laser light source 11a is an end face-emitting laser diode. The laser light source 11a may be a surface-emitting laser light source. In the present embodiment, it is assumed that the laser radar 1 is mounted on a vehicle. Therefore, the emission wavelength of each laser light source 11a is set in the infrared wavelength band (for example, 905 nm). The emission wavelength of each laser light source 11a can be changed as appropriate according to the usage of the laser radar 1.

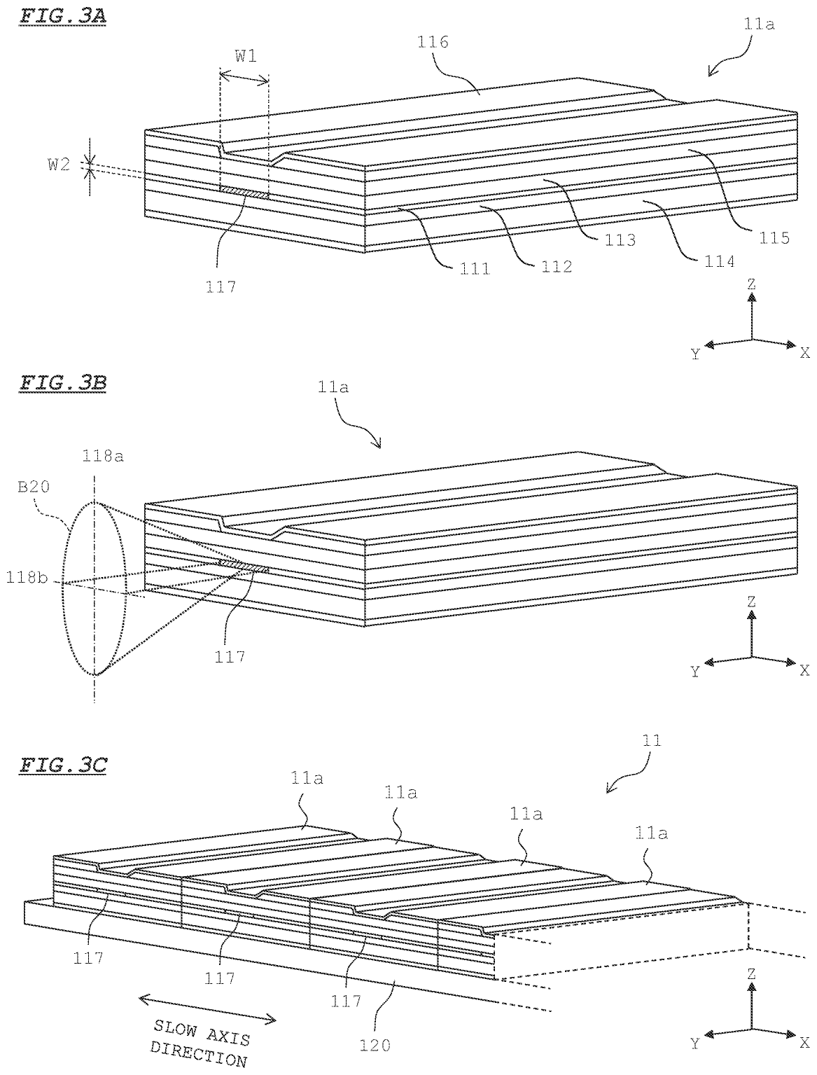

FIG. 3A and FIG. 3B are each a perspective view showing a configuration of the laser light source 11a, and FIG. 3C is a perspective view showing a configuration of the light source array 11.

As shown in FIG. 3A, the laser light source 11a has a structure in which an active layer 111 is interposed between an N-type clad layer 112 and a P-type clad layer 113. The N-type clad layer 112 is laminated on an N-type substrate 114. In addition, a contact layer 115 is laminated on the P-type clad layer 113. When a current is applied to an electrode 116, laser light is emitted from a light emitting region 117 in the Y-axis positive direction. In general, in the light emitting region 117, a width W1 in a direction parallel to the active layer 111 is larger than a width W2 in a direction perpendicular to the active layer 111.

An axis in the short side direction of the light emitting region 117, that is, an axis in the direction (Z-axis direction) perpendicular to the active layer 111, is referred to as a fast axis, and an axis in the long side direction of the light emitting region 117, that is, an axis in the direction (X-axis direction) parallel to the active layer 111, is referred to as a slow axis. In FIG. 3B, reference character 118a denotes the fast axis, and reference character 118b denotes the slow axis. The laser light emitted from the light emitting region 117 has a spread angle in the fast axis direction larger than that in the slow axis direction. Thus, a beam B20 has an elliptical shape that is long in the fast axis direction as shown in FIG. 3B.

As shown in FIG. 3C, the plurality of (for example, four) laser light sources 11a are installed on a base 120 so as to be aligned along the slow axis, whereby the light source array 11 is configured. Therefore, the light emitting regions 117 of the respective laser light sources 11a are aligned in one row in the slow axis direction. Here, each laser light source 11a is placed such that the fast axis 118a of the light emitting region 117 is parallel to the direction corresponding to the short side direction of the line beam B10 shown in FIG. 2. The plurality of laser light sources 11a forming the light source array 11 all have emission characteristics that are distributed within a certain range described in the specifications thereof, although there are individual differences therebetween.

In FIG. 3C, the light source array 11 is configured by installing the plurality of laser light sources 11a on the base 120 such that the laser light sources 11a are adjacent to each other. However, one semiconductor light emitting element in which a plurality of light emitting regions 117 are formed so as to be aligned in the slow axis direction may be installed on the base 120. In this case, structural portions, of the semiconductor light emitting element, which emit laser light from the respective light emitting regions 117 correspond to the laser light sources 11a, respectively.

Referring to FIG. 1 and FIG. 2, the fast axis cylindrical lens 12 converges the laser light emitted from each laser light source 11a of the light source array 11, in the fast axis direction, and adjusts the spread of the laser light in the fast axis direction (Z-axis direction) to a substantially parallel state. That is, the fast axis cylindrical lens 12 has an action of converting the laser light emitted from each laser light source 11a of the light source array 11 into collimated light only in the fast axis direction.

The fast axis cylindrical lens 12 has a lens surface 12a curved only in a direction parallel to the Y-Z plane. The generatrix of the lens surface 12a is parallel to the X axis. The fast axis of each laser light incident on the fast axis cylindrical lens 12 is perpendicular to the generatrix of the lens surface 12a. Each laser light is incident on the fast axis cylindrical lens 12 so as to be aligned in the X-axis direction. Each laser light undergoes a convergence action in the fast axis direction (Z-axis direction) at the lens surface 12a to be converted into collimated light in the fast axis direction.

The light guide 13 guides the laser light converted into collimated light in the fast axis direction by the fast axis cylindrical lens 12, to the slow axis cylindrical lens 14. The light guide 13 has two surfaces 13a and 13b opposing each other in the long side direction of the line beam B10, reflects the laser light at these two surfaces 13a and 13b to confine the laser light inside the light guide 13, and causes the mixed laser light to be incident on the slow axis cylindrical lens 14.

The light guide 13 is made of a material having excellent light transmission properties such as resin or glass. The light guide 13 has a rectangular parallelepiped shape. The incident surface and the emission surface of the light guide 13 are parallel to the X-Z plane, and the upper surface and the lower surface of the light guide 13 are parallel to the X-Y plane. The two surfaces 13a and 13b, which form the side surfaces of the light guide 13, are parallel to each other. The light guide 13 is placed such that the center position in the width direction thereof (X-axis direction) coincides with the center position of the width W1 over which the plurality of laser light sources 11a are aligned. That is, the central axis of a beam incident on the light guide 13 (here, the beam formed by the plurality of laser light sources 11a) is positioned at the center position in the width direction of the light guide 13 (X-axis direction) in the X-axis direction.

In the present embodiment, since the slow axis of each laser light source 11a is parallel to the X-axis direction, the spread angle in the X-axis direction of the laser light that has passed through the fast axis cylindrical lens 12 is small as shown in FIG. 2. Therefore, substantially the entirety of the laser light passes through the incident surface and the emission surface of the light guide 13, and the laser light is incident on the two surfaces 13a and 13b inside the light guide 13 at an incidence angle that satisfies a total reflection condition. Therefore, in particular, even without forming reflection surfaces on the surfaces 13a and 13b, the laser light incident on the light guide 13 is substantially totally reflected by the surfaces 13a and 13b.

In order to more favorably totally reflect the laser light, preferably, the surfaces 13a and 13b are optically polished surfaces. Alternatively, reflection films may be formed on the surfaces 13a and 13b. Antireflection films may be formed on the incident surface and the emission surface of the light guide 13. Since the laser light is converted into collimated light in the Z-axis direction by the fast axis cylindrical lens 12, the laser light is not incident on the upper surface and the lower surface of the light guide 13 and is emitted from the emission surface of the light guide 13.

The slow axis cylindrical lens 14 condenses the laser light emitted from the light guide 13, in the long side direction of the line beam B10, and causes the laser light to be incident on a mirror 15a of the light deflector 15. The slow axis cylindrical lens 14 has a lens surface 14a curved only in a direction parallel to the X-Y plane. The generatrix of the lens surface 14a is parallel to the Z axis. The generatrices of the lens surface 12a and 14a are perpendicular to each other.

The light deflector 15 is, for example, a MEMS (micro electro mechanical systems) mirror using a piezoelectric actuator, an electrostatic actuator, or the like. The mirror 15a has a reflectance increased by a dielectric multilayer film, a metal film, or the like. The mirror 15a is placed at a position near the focal distance on the Y-axis positive side of the slow axis cylindrical lens 14. The mirror 15a is driven so as to rotate about a rotation axis R1 parallel to the X axis. The mirror 15a has, for example, a circular shape with a diameter of about 3 mm.

The diffusion optical element 16 diffuses the laser light incident thereon from the mirror 15a side, in the X-axis direction. The diffusion optical element 16 has a plate-like shape curved in an arc shape about the rotation axis R1 of the mirror 15a. That is, the diffusion optical element 16 has a shape obtained by curving a flat plate whose incident surface and emission surface are parallel to each other, in an arc shape. Either one of or both the incident surface and the emission surface of the diffusion optical element 16 are diffusion surfaces that diffuse the laser light. Here, the emission surface is a diffusion surface 16a.

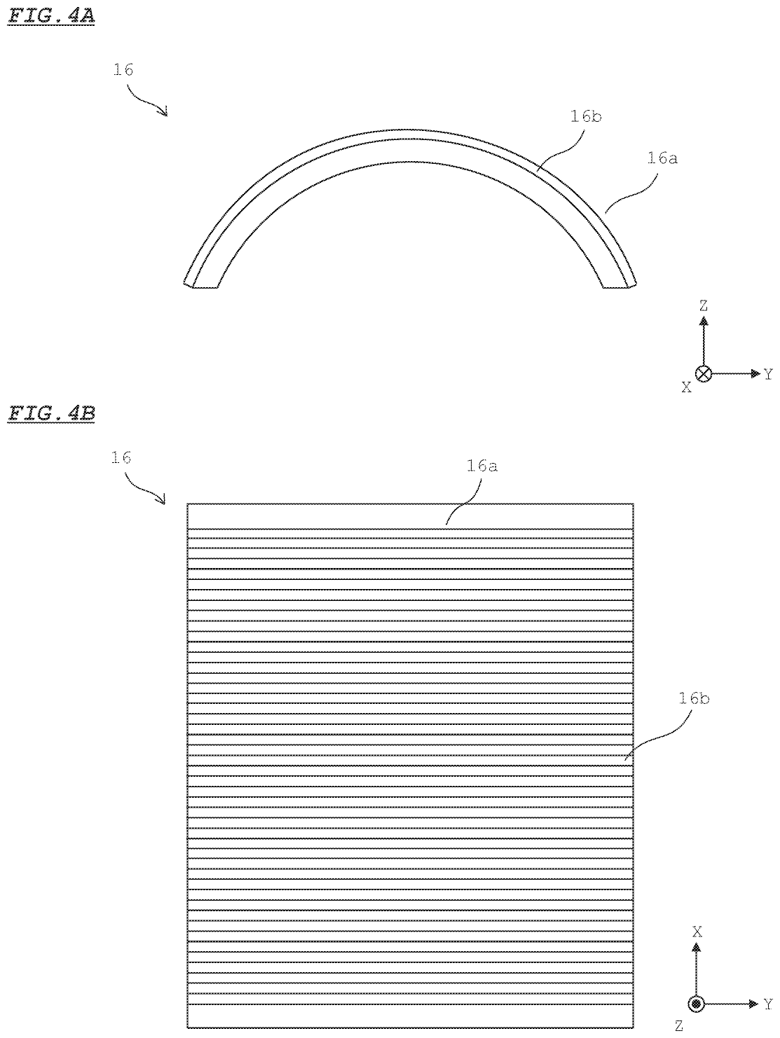

FIG. 4A and FIG. 4B are respectively a top view and a front view schematically showing a configuration of the diffusion optical element 16.

As shown in FIG. 4A and FIG. 4B, a large number of microlenses 16b each having a semicircular cross-section are formed on the diffusion surface 16a of the diffusion optical element 16. The microlenses 16b have ridges extending in a direction along the arc (circumferential direction of the diffusion optical element 16), and are aligned without gaps in the X-axis direction. Each laser light diffused by the microlenses 16b overlaps each other to generate the line beam B10. A curved surface of each microlens 16b is optimally designed as an aspherical surface such that the intensity distribution of the formed line beam is as wide-angled and flat as possible.

Since the diffusion optical element 16 diffuses the laser light to generate the line beam B10 as described above, the light-emitting region of the line beam B10 on the diffusion surface 16a of the diffusion optical element 16 becomes an apparent light source for which eye-safe determination is performed. In the case where the diffusion optical element 16 is not used, a small region where each laser light overlaps on the mirror 15a of the light deflector 15 becomes an apparent light source for which eye-safe determination is performed. Therefore, according to the present embodiment, the light-emitting area of the apparent light source can be significantly increased as compared to the case where the diffusion optical element 16 is not used, so that the influence of the line beam B10 on human eyes can be significantly suppressed.

In the configuration example in FIG. 4A and FIG. 4B, each microlens 16b is a convex lens, but each microlens 16b may be a concave lens.

Referring back to FIG. 1, the light deflector 15 drives the mirror 15a on the basis of a driving signal from a mirror driving circuit 33 and performs scanning in the Y-axis direction with the beam reflected from the mirror 15a. Accordingly, scanning is performed in the short side direction (Y-axis direction) with the line beam B10. In the configuration in FIG. 1, the mirror 15a is tilted at 45° with respect to the emission optical axis of each laser light source 11a in a state where the mirror 15a is at a neutral position, but the tilt angle of the mirror 15a with respect to the emission optical axis of each laser light source 11a is not limited thereto. The tilt angle of the mirror 15a can be changed as appropriate according to the layout of the line beam scanning optical system 10.

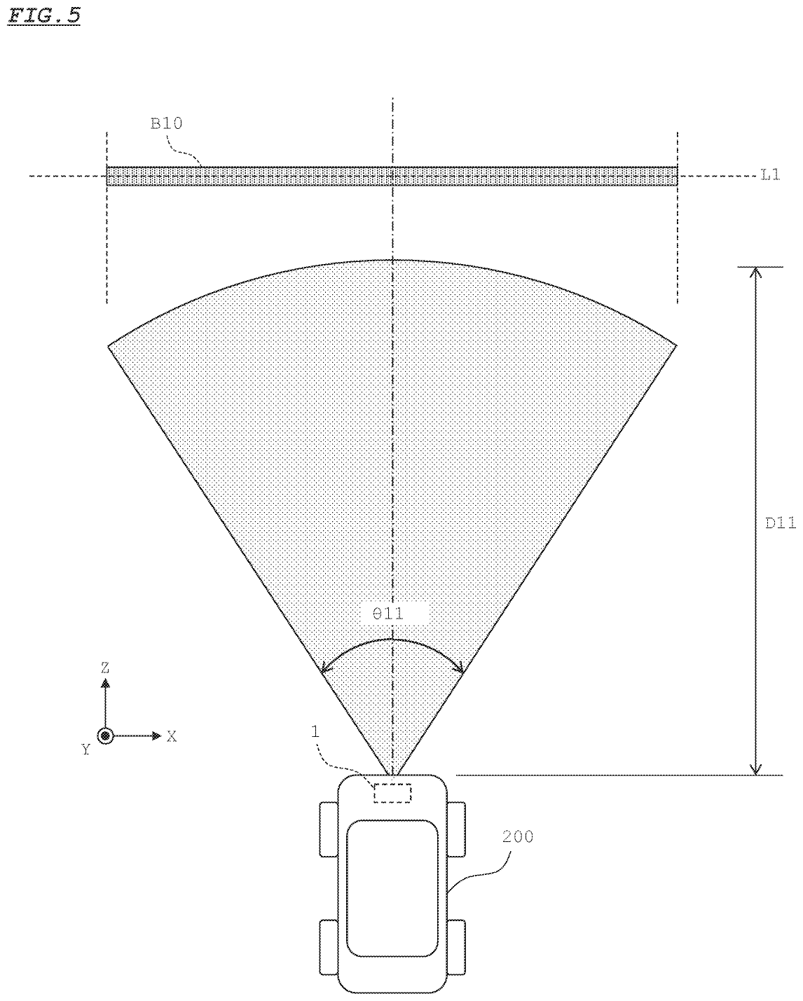

FIG. 5 is a diagram schematically showing an emission state of the laser light of the laser radar 1 and a state of the line beam B10 in a target region. The upper part of FIG. 5 schematically shows a cross-sectional shape of the line beam B10 as viewed in the projection direction (Z-axis positive direction).

As shown in FIG. 5, in the present embodiment, the laser radar 1 is mounted on the front side of a vehicle 200, and the line beam B10 is projected to the front of the vehicle 200. A spread angle θ11 in the long side direction of the line beam B10 is, for example, 90°. In addition, the upper limit of a distance D11 within which object detection is possible is, for example, about 250 m. For convenience, in FIG. 5, the spread angle θ11 is represented so as to be smaller than it actually is.

Referring back to FIG. 1, the reflected light, of the line beam B10, reflected from the target region is condensed on a light receiving surface of the light receiving element 22 by the light receiving lens 21. The light receiving lens 21 is, for example, a camera lens unit for imaging which is composed of a plurality of lenses, and the light receiving element 22 is, for example, an image sensor or sensor array in which pixels are arranged vertically and horizontally in a matrix. In an example of the sensor array, an avalanche photodiode sensor may be placed at each pixel position. In this case, the avalanche photodiode is used, for example, in a Geiger mode (Geiger multiplication mode). In the Geiger mode, when a photon enters the avalanche photodiode, the charge collected on the cathode of the avalanche photodiode is multiplied to a saturation charge amount by avalanche multiplication. Therefore, the presence/absence of light incident on the pixel is detected with high sensitivity, enabling distance measurement at a longer distance.

The light receiving element 22 has, for example, a rectangular light receiving surface, and is placed such that the long sides of the light receiving surface are parallel to the X axis. The long side direction of the light receiving surface of the light receiving element 22 corresponds to the long side direction of the line beam B10 in the target region. The reflected light of the line beam B10 is imaged on the light receiving surface of the light receiving element 22 by the light receiving lens 21 so as to extend along the long side direction of the light receiving surface.

Here, a pixel position in the X-axis direction of the light receiving surface corresponds to a position in the X-axis direction in the target region. In addition, a pixel position in the Y-axis direction of the light receiving surface corresponds to a position in the Y-axis direction in the target region. When scanning is performed with the line beam B10 in the Y-axis direction, the reflected light of the line beam B10 moves on the light receiving surface of the light receiving element 22 in the Y-axis direction. Therefore, the position of an object in the X-axis direction and the Y-axis direction in the target region can be detected on the basis of the positions of pixels at each of which a light reception signal is generated.

A line sensor in which pixels are aligned in the X-axis direction may be used as the light receiving element 22. In this case, a Y position of an object to be detected is specified in synchronization with movement of the line beam B10.

The laser radar 1 includes a controller 31, a laser driving circuit 32, the mirror driving circuit 33, and a signal processing circuit 34 as components of the circuitry.

The controller 31 includes an arithmetic processing circuit such as a CPU (central processing unit) and a storage medium such as a ROM (read only memory) and a RAM (random access memory), and controls each part according to a preset program. The laser driving circuit 32 causes the respective laser light sources 11a of the light source array 11 to emit light in a pulsed manner in accordance with the control from the controller 31. The controller 31 causes each laser light source 11a to repeatedly emit light in a pulsed manner a plurality of times at a timing when the movement position of the reflected light of the line beam B10 is included in each pixel row of the light receiving element 22. At the time of pulsed emission, the laser driving circuit 32 causes the respective laser light sources 11a to simultaneously emit light in a pulsed manner. Alternatively, the laser driving circuit 32 may cause the respective laser light sources 11a to take turns in emitting light with a predetermined time difference.

The mirror driving circuit 33 drives the light deflector 15 in accordance with the control from the controller 31. The light deflector 15 rotates the mirror 15a about the rotation axis R1 and performs scanning with the line beam B10 in the short side direction of the line beam B10.

The signal processing circuit 34 outputs a light reception signal at each pixel of the light receiving element 22 to the controller 31. As described above, the controller 31 can detect the position of an object in the X-axis direction in the target region on the basis of the positions of pixels at each of which a light reception signal is generated. In addition, the controller 31 obtains the distance to the object existing in the target region, on the basis of the time difference between a timing when the light source array 11 is caused to emit light in a pulsed manner and a timing when the light receiving element 22 receives reflected light from the target region, that is, a timing when the light reception signal is received from the light receiving element 22.

As described above, the controller 31 detects the presence/absence of an object in the target region by causing the light deflector 15 to perform scanning with the line beam B10 while causing the light source array 11 to emit light in a pulsed manner, and further measures the position of the object and the distance to the object. These measurement results are constantly transmitted to a control unit on the vehicle side during operation.

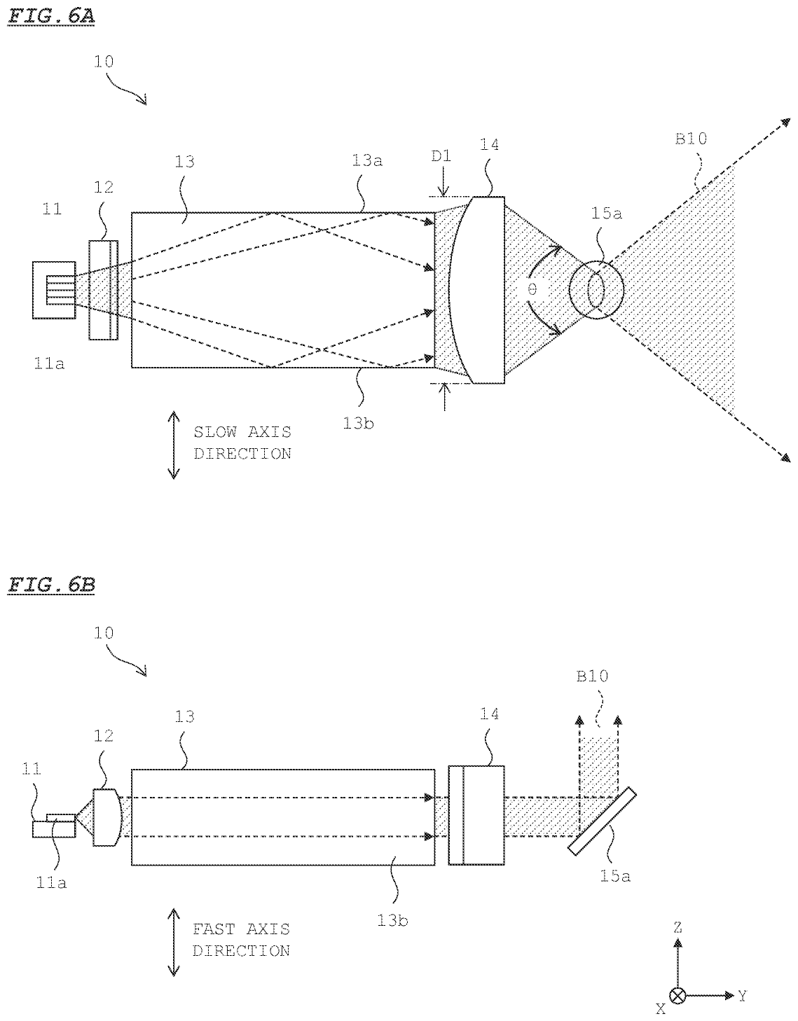

FIG. 6A and FIG. 6B are each a diagram schematically showing the action of the light guide 13. For convenience, FIG. 6A shows a state where the optical system from the light source array 11 to the diffusion optical element 16 is developed on one plane. In addition, in FIG. 6A and FIG. 6B, the laser light beam is shown by dashed arrows.

As shown in FIG. 6A, the beam width of the laser light emitted from each laser light source 11a is widened in the long side direction of the line beam B10 (slow axis direction) by the light guide 13, and the laser light is incident on the slow axis cylindrical lens 14. That is, the laser light is emitted from the light guide 13 at the width of the emission surface of the light guide 13, and is incident on the slow axis cylindrical lens 14 while spreading in the slow axis direction. In the slow axis direction, an effective diameter D1 of the slow axis cylindrical lens 14 is larger than the width of the light guide 13. Therefore, the laser light emitted from the light guide 13 is taken into the slow axis cylindrical lens 14 as it is, and is condensed in the slow axis direction.

Thus, since the beam width of the laser light incident on the slow axis cylindrical lens 14 is widened in the slow axis direction, the laser light is condensed in the long side direction at a large condensing angle θ by the slow axis cylindrical lens 14 and is incident on the mirror 15a. As a result of the beam width being widened, the light is incident on an outer peripheral portion of the slow axis cylindrical lens 14 at which the tilt thereof is steep, so that the spread angle in the long side direction (slow axis direction) of the line beam B10 formed by the laser light reflected by the mirror 15a is increased. In addition, the laser light is mixed by repeated reflection on the surfaces 13a and 13b of the light guide 13 which oppose each other, and the intensity distribution of the laser light in the long side direction (slow axis direction) is made uniform. The length of the light guide 13 is set such that the intensity distribution of the laser light in the long side direction can be made uniform by repeated reflection of the laser light on the surfaces 13a and 13b.

Therefore, in the line beam scanning optical system 10 according to the present embodiment, widening the angle of the line beam B10 and making the radiation intensity distribution of the line beam B10 uniform can be simultaneously achieved even in the case where the number of laser light sources to be arranged is small.

Since the laser light is converted into collimated light by the fast axis cylindrical lens 12, the laser light incident on the light guide 13 travels straight inside the light guide 13 while remaining as collimated light, without being reflected by the upper surface and the lower surface of the light guide 13, as shown in FIG. 6B. Therefore, the beam width in the short side direction (fast axis direction) of the line beam B10 is defined as the beam width of the line beam B10 when the line beam B10 is converted into collimated light by the fast axis cylindrical lens 12. Thus, the line beam B10 whose angle is widened and whose radiation intensity distribution is made uniform is projected while the beam width in the short side direction is maintained.

### Effects of Embodiment

According to the present embodiment, the following effects are achieved.

As described with reference to FIG. 6A and FIG. 6B, the beam width of the laser light emitted from each laser light source 11a is widened in the long side direction of the line beam B10 by the light guide 13, and the laser light is incident on the slow axis cylindrical lens 14 (lens). Accordingly, the laser light is condensed in the long side direction at the large condensing angle θ and is incident on the mirror 15a, so that the spread angle of the laser light reflected by the mirror 15a can be widened. In addition, the laser light is mixed by repeated reflection on the surfaces 13a and 13b of the light guide 13 which oppose each other, and the intensity distribution of the laser light in the long side direction is made uniform. Therefore, in the line beam scanning optical system 10 according to the present embodiment, widening the angle of the line beam B10 and making the radiation intensity distribution of the line beam B10 uniform can be simultaneously achieved even in the case where the number of laser light sources 11a to be arranged is small.

As shown in FIG. 1 and FIG. 2, the slow axis cylindrical lens 14 (lens) condenses the laser light only in the long side direction of the line beam B10, the line beam scanning optical system 10 includes the fast axis cylindrical lens 12 (other lens) which converts the laser light emitted from each laser light source 11a, into collimated light in the short side direction of the line beam B10, and the light guide 13 is placed between the slow axis cylindrical lens 14 (lens) and the fast axis cylindrical lens 12 (other lens). Accordingly, as described with reference to FIG. 6A and FIG. 6B, while the beam width in the short side direction of the line beam B10 is defined by the fast axis cylindrical lens 12, widening the angle of the line beam B10 and making the radiation intensity distribution of the line beam B10 uniform can be achieved by the light guide 13.

As shown in FIG. 6A, each laser light source 11a is placed such that the slow axis direction thereof is parallel to the long side direction of the line beam B10, and the laser light is incident on the two surfaces 13a and 13b at an incidence angle that satisfies the total reflection condition. Accordingly, even without forming reflection films on the two surfaces 13a and 13b of the light guide 13, the laser light can be inhibited from leaking from the two surfaces 13a and 13b of the light guide 13. Therefore, the configuration of the light guide 13 can be simplified and the cost of the light guide 13 can be reduced.

As shown in FIG. 6A, the plurality of laser light sources 11a are arranged so as to be aligned in the long side direction of the line beam B10, and the width of the light guide 13 in the long side direction of the line beam B10 is larger than the width W1 over which the plurality of laser light sources 11a are aligned. Accordingly, the beam width in the long side direction of the laser light that is emitted from the emission surface of the light guide 13 and incident on the slow axis cylindrical lens 14 can be made wider than the width W1 over which the plurality of laser light sources 11a are aligned. Therefore, the condensing angle θ of the laser light condensed on the mirror 15a can be increased, so that the angle of the line beam B10 can be properly widened.

As shown in FIG. 6A, in the long side direction of the line beam B10, the effective diameter D1 of the slow axis cylindrical lens 14 (lens) is larger than the width of the emission surface of the light guide 13. More specifically, the effective diameter D1 of the slow axis cylindrical lens 14 (lens) is larger than the beam width of the laser light when the laser light is incident on the slow axis cylindrical lens 14 after being emitted from the emission surface of the light guide 13. Accordingly, the laser light emitted from the light guide 13 is taken into the slow axis cylindrical lens 14 as it is, and is condensed in the slow axis direction. Therefore, the utilization efficiency of the laser light can be increased, and the radiation energy of the line beam B10 can be increased.

As shown in FIG. 1, the laser radar 1 includes the line beam scanning optical system 10 configured as described above. Therefore, as shown in FIG. 2, widening the angle of the line beam B10 and making the radiation intensity distribution of the line beam B10 uniform can be simultaneously achieved even in the case where the number of laser light sources 11a to be arranged is small.

<Modification 1>

In the above embodiment, the light guide 13 has a rectangular parallelepiped shape. However, in Modification 1, a light guide is composed of a prism.

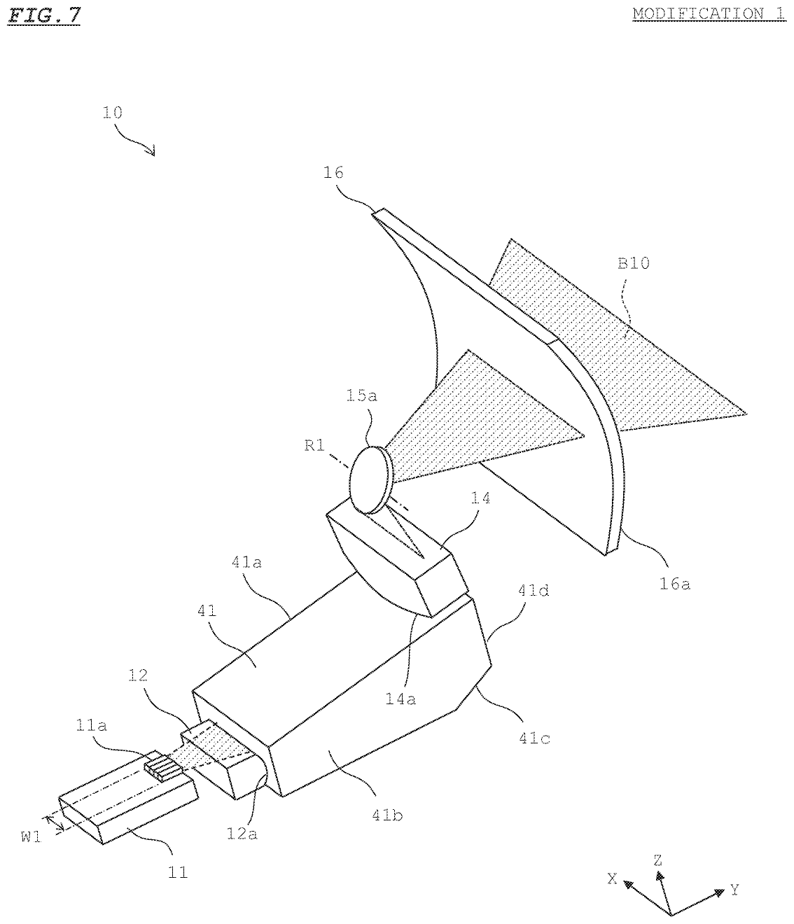

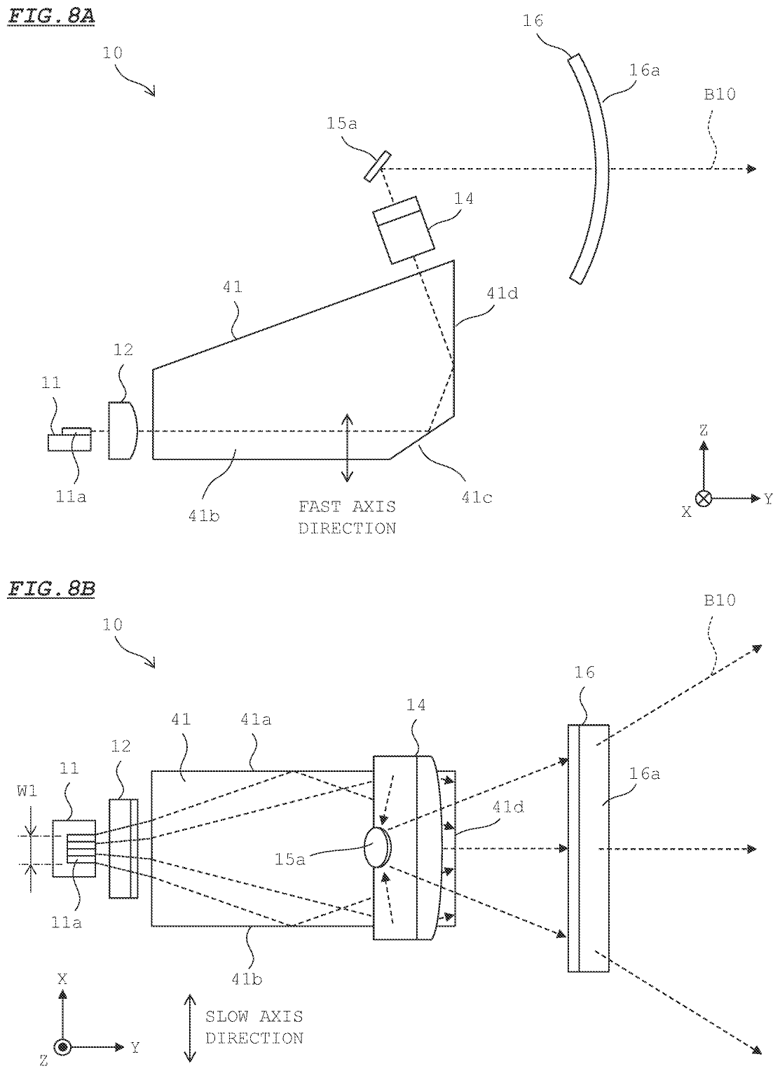

FIG. 7 is a perspective view showing a configuration of a line beam scanning optical system 10 according to Modification 1. FIG. 8A and FIG. 8B are respectively a side view and a plan view showing the configuration of the line beam scanning optical system 10 according to Modification 1. In FIG. 8A and FIG. 8B, a laser light beam is shown by dashed arrows.

As shown in FIG. 7, FIG. 8A, and FIG. 8B, in Modification 1, a light guide 41 composed of a prism is placed between the fast axis cylindrical lens 12 and the slow axis cylindrical lens 14. The width in the X-axis direction of the light guide 41 is constant. The light guide 41 is placed such that in the X-axis direction, the middle position of the width in the X-axis direction thereof coincides with the middle position of the width W1 over which the plurality of laser light sources 11a are aligned. The light guide 41 is integrally formed from a material having excellent light transmission properties such as resin or glass. The configuration of the line beam scanning optical system 10 other than the light guide 41 is the same as that of the above embodiment.

The light guide 41 has a lower surface parallel to the X-Y plane, and an upper surface tilted relative to the X-Y plane. As in the above embodiment, the light guide 41 has surfaces 41a and 41b opposing each other in the X-axis direction. The surfaces 41a and 41b are parallel to the Y-Z plane and are parallel to each other. The light guide 41 further has other surfaces 41c and 41d which bend the optical path of the laser light in a direction parallel to the Y-Z plane. The other surfaces 41c and 41d each have a tilt angle that is set so as to satisfy a total reflection condition for the laser light traveling inside the light guide 41.

The upper surface of the light guide 41 has a tilt angle that is set such that the upper surface is perpendicular to the central axis of the laser light emitted from the upper surface. The slow axis cylindrical lens 14 is placed near the upper surface so as to face the upper surface. As in the above embodiment, the effective diameter of the slow axis cylindrical lens 14 is larger than the width of the light guide 41. Therefore, the laser light emitted from the upper surface of the light guide 41 is taken into the slow axis cylindrical lens 14 as it is, and is condensed on the mirror 15a by the slow axis cylindrical lens 14. The laser light reflected by the mirror 15a spreads in a direction parallel to the X-Y plane at a spread angle equal to the condensing angle of the laser light when the laser light is incident on the mirror 15a. Accordingly, the line beam B10 that is long in the X-axis direction is formed.

<Effects of Modification 1>

In Modification 1 as well, as in the above embodiment, the beam width of the laser light emitted from each laser light source 11a is widened in the long side direction of the line beam B10 by the light guide 41, and the laser light is incident on the slow axis cylindrical lens 14 (lens). Accordingly, the laser light is condensed in the long side direction at a large condensing angle and is incident on the mirror 15a, so that the spread angle of the laser light reflected by the mirror 15a can be widened. In addition, the laser light is mixed by repeated reflection on the surfaces 41a and 41b of the light guide 41 which oppose each other, and the intensity distribution of the laser light in the long side direction is made uniform. Therefore, widening the angle of the line beam B10 and making the radiation intensity distribution of the line beam B10 uniform can be simultaneously achieved even in the case where the number of laser light sources 11a to be arranged is small.

As shown in FIG. 8A, the light guide 41 has the other surfaces 41c and 41d which bend the optical path in the short side direction of the line beam B10. Accordingly, the length in the Y-axis direction and the length in the Z-axis direction of the light guide 41 can be adjusted while ensuring that the distance of the laser light traveling inside the light guide 41 is long enough to allow mixing of the laser light. Therefore, the shape of the line beam scanning optical system 10 can be adapted to the size and shape required for the optical system from a system in which the optical system is installed.

As shown in FIG. 7, FIG. 8A, and FIG. 8B, the light guide 41 is composed of a prism in which the two surfaces 41a and 41b and the other surfaces 41c and 41d are integrally formed. Accordingly, by merely installing the light guide 41, the two surfaces 41a and 41b and the other surfaces 41c and 41d can be placed between the fast axis cylindrical lens 12 and the slow axis cylindrical lens 14, which can improve the workability.

As described with reference to FIG. 8A, similar to the surfaces 41a and 41b which oppose each other, the other surfaces 41c and 41d each have a tilt angle that is set so as to satisfy the total reflection condition for the laser light traveling inside the light guide 41. Accordingly, even without forming reflection films on the two surfaces 41a and 41b and the other surfaces 41c and 41d of the light guide 41, the laser light can be inhibited from leaking from these surfaces. Therefore, the configuration of the light guide 14 can be simplified and the cost of the light guide 14 can be reduced.

<Modification 2>

In the above embodiment and Modification 1, only one light guide is placed. However, the light guide may be divided into a plurality of parts along the optical path of the laser light.

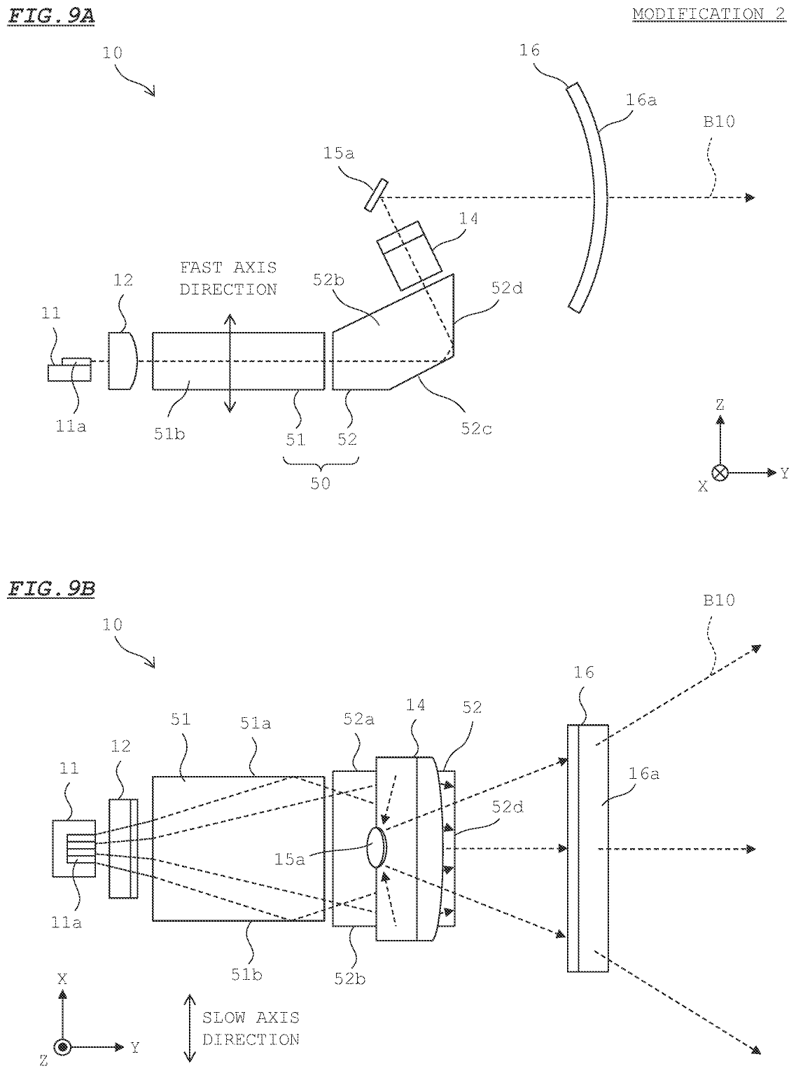

FIG. 9A and FIG. 9B are respectively a side view and a plan view showing a configuration of a line beam scanning optical system 10 according to Modification 2.

As shown in FIG. 9A and FIG. 9B, in Modification 2, a light guide 50 is divided into two parts along the optical path of the laser light. That is, the light guide 50 is composed of two light guides 51 and 52 aligned along the optical path. The two light guides 51 and 52 are placed between the fast axis cylindrical lens 12 and the slow axis cylindrical lens 14 such that adjacent end surfaces thereof are close to each other. The light guides 51 and 52 are made of a material having high light transmission properties such as resin or glass. The configuration of the line beam scanning optical system 10 other than the light guides 51 and 52 is the same as those of the above embodiment and Modification 1.

The light guide 51 has a rectangular parallelepiped shape, and the light guide 52 is a prism. The light guide 51 has surfaces 51a and 51b opposing each other. The light guide 52 has surfaces 52a and 52b opposing each other, and other surfaces 52c and 52d. In the optical path of the emission light from the light guide 51 to the light guide 52, the light diverges to spread in the X-axis direction, and for the purpose of preventing end portions of this light in the X-axis positive and negative directions from deviating from the incident surface of the light guide 52 and not being incident on the light guide 52, the width in the X-axis direction of the emission surface of the light guide 51 is narrower than the width in the X-axis direction of the incident surface of the light guide 52. As in the above embodiment and Modification 1, the surfaces 51a and 51b and the surfaces 52a and 52b act to totally reflect the laser light spreading in the slow axis direction, to mix the laser light. As in Modification 1 above, the other surfaces 52c and 52d act to bend the optical path of the laser light in the short side direction of the line beam B10. In Modification 2 as well, as in Modification 1, the line beam B10 that is long in the X-axis direction is generated by the actions of these surfaces and the other optical elements.

<Effects of Modification 2>

In Modification 2 as well, as in the above embodiment and Modification 1, the beam width of the laser light emitted from each laser light source 11a is widened in the long side direction of the line beam B10 by the light guides 51 and 52, and the laser light is incident on the slow axis cylindrical lens 14 (lens). Accordingly, the laser light is condensed in the long side direction at a large condensing angle and is incident on the mirror 15a, so that the spread angle of the laser light reflected by the mirror 15a can be widened. In addition, the laser light is mixed by repeated reflection on the surfaces 51a and 51b of the light guide 51 which oppose each other and the surfaces 52a and 52b of the light guide 52 which oppose each other, and the intensity distribution of the laser light in the long side direction is made uniform. Therefore, widening the angle of the line beam B10 and making the radiation intensity distribution of the line beam B10 uniform can be simultaneously achieved even in the case where the number of laser light sources 11a to be arranged is small.

As shown in FIG. 9A and FIG. 9B, the light guide 50 is divided into two parts along the optical path of the laser light. Accordingly, the shapes of the light guides 51 and 52 can be made simpler and more compact. That is, the shape of the light guide 51 may be set only in consideration of reflecting the laser light spreading in the slow axis direction, at the surfaces 51a and 51b. In addition, the shape of the light guide 52 may be set only in consideration of reflecting the laser light spreading in the slow axis direction, at the surfaces 52a and 52b, and bending the optical path of the laser light at the surfaces 52c and 52d. Accordingly, the shape of the light guide 50 can be designed as a shape that makes it easier to produce the light guide 50.

FIG. 9A and FIG. 9B show a configuration example in the case where the light guide 41 shown in FIG. 8A and FIG. 8B is divided into two parts, but the light guide 13 having a rectangular parallelepiped shape shown in FIG. 1 and FIG. 2 may be divided into a plurality of parts in the longitudinal direction thereof (Y-axis direction). Also, the number of parts into which the light guide is divided is not limited to two, and may be three or more.

<Modification 3>

In each of Modifications 1 and 2, the other surfaces 41c and 41d or 52c and 52d of the light guide 50, which bend the optical path of the laser light, each have a tilt angle that is set so as to satisfy the total reflection condition for the laser light. However, these other surfaces may be tilted at a tilt angle that does not satisfy the total reflection condition for the laser light. In this case, reflection films are formed on the other surfaces.

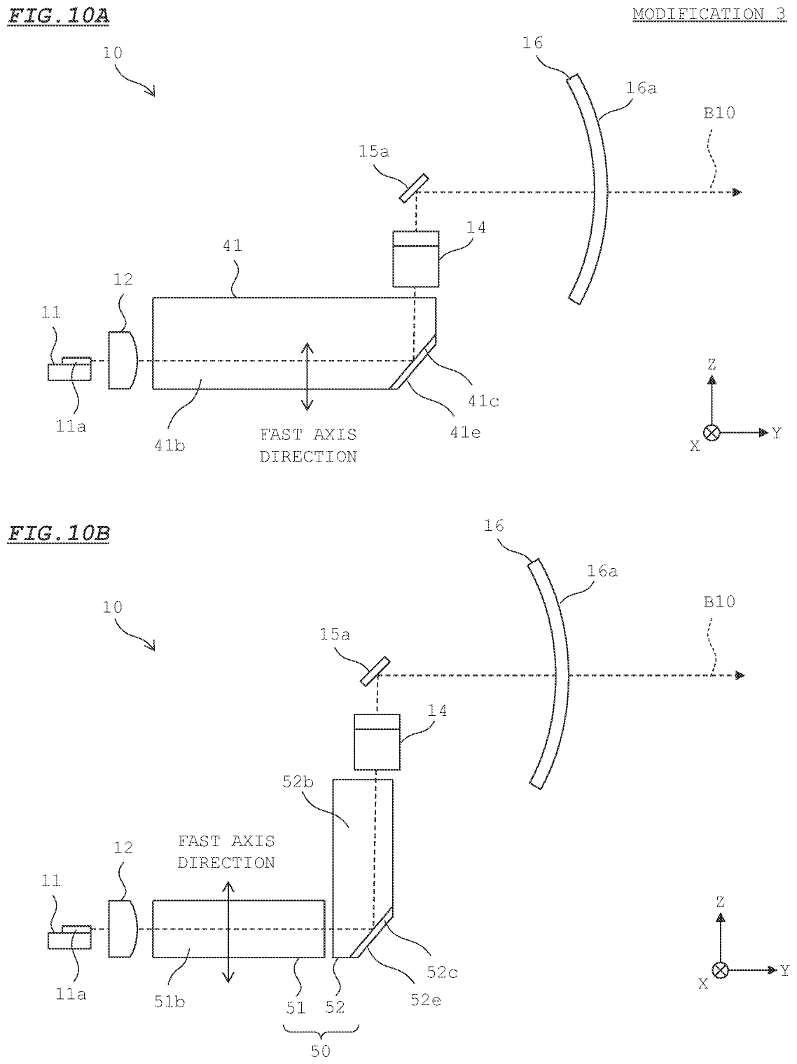

FIG. 10A and FIG. 10B are each a side view showing a configuration example of a line beam scanning optical system 10 according to Modification 3.

In the configuration example in FIG. 10A, the tilt angle of the other surface 41c in the line beam scanning optical system 10 of Modification 1 shown in FIG. 8A and FIG. 8B is changed to a tilt angle that does not satisfy the total reflection condition for the laser light. A reflection film 41e is formed on the other surface 41c, and accordingly, the laser light is prevented from leaking from the other surface 41c.

In this configuration example, since the tilt angle of the other surface 41c is large, the optical path of the laser light traveling through the light guide 41 in the Y-axis positive direction is bent in the Z-axis positive direction by the other surface 41c and the reflection film 41e. The upper surface of the light guide 41 is parallel to the X-Y plane. The other configuration and action of the light guide 41 is the same as that of the light guide 41 of Modification 1.

In the configuration example in FIG. 10B, the tilt angle of the other surface 52c in the line beam scanning optical system 10 of Modification 2 shown in FIG. 9A and FIG. 9B is changed to a tilt angle that does not satisfy the total reflection condition for the laser light. A reflection film 52e is formed on the other surface 52c, and accordingly, the laser light is prevented from leaking from the other surface 52c.

In this configuration example, since the tilt angle of the other surface 52c is large, the optical path of the laser light traveling through the light guide 52 in the Y-axis positive direction is bent in the Z-axis positive direction by the other surface 52c and the reflection film 52e. The upper surface of the light guide 52 is parallel to the X-Y plane. The other configuration and action of the light guide 52 is the same as that of the light guide 52 of Modification 2.

In each of the configuration examples in FIG. 10A and FIG. 10B, the slow axis cylindrical lens 14 is placed so as to be parallel to the X-Y plane. In Modification 3 as well, as in Modifications 1 and 2, the line beam B10 that is long in the X-axis direction is generated by the actions of each surface of the light guide 41 or 50 and the other optical elements.

<Effects of Modification 3>

As shown in FIG. 10A and FIG. 10B, the reflection films 41e and 52e are formed on the other surfaces 41c and 52c. Accordingly, the optical path of the laser light traveling inside the light guide 52 in the Y-axis positive direction can be bent at any angle. Therefore, the degree of freedom of the layout of each optical component included in the line beam scanning optical system 10 can be increased.

Also, in the configuration in FIG. 10B, the length in the Z-axis direction of the light guide 52 is set longer. Accordingly, the optical path of the laser light in the light guide 52 can be made longer, and the mixing of the laser light is more easily advanced. Therefore, the intensity distribution in the slow axis direction of the laser light that is emitted from the light guide 52 and incident on the slow axis cylindrical lens 14 can be made more uniform.

<Modification 4>

In the above embodiment, the line beam B10 is generated using two lenses, that is, the fast axis cylindrical lens 12 and the slow axis cylindrical lens 14. However, the line beam B10 may be generated using one lens.

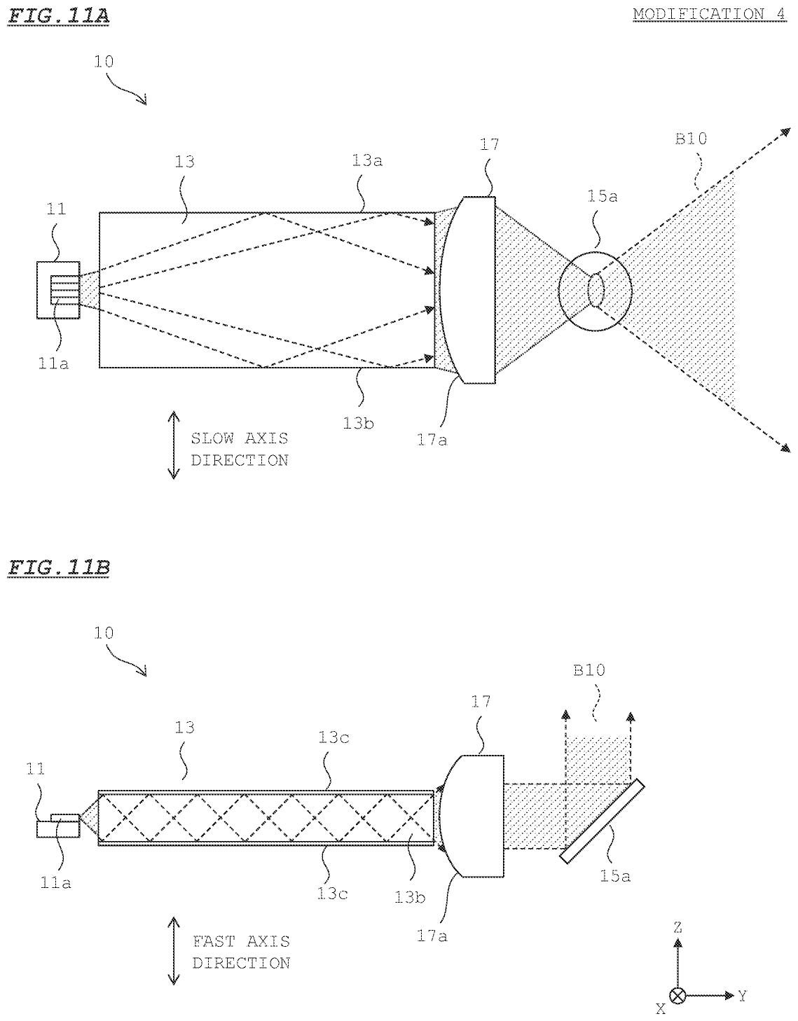

FIG. 11A and FIG. 11B are respectively a plan view and a side view showing a configuration of a line beam scanning optical system 10 according to Modification 4. As in FIG. 6A, for convenience, FIG. 11A shows a state where the optical system from the light source array 11 to the diffusion optical element 16 is developed on one plane.

In the configuration in FIG. 11A and FIG. 11B, the fast axis cylindrical lens 12 is omitted, and one lens 17 is placed at the exit of the light guide 13. The lens 17 has an incident surface 17a formed as a toroidal surface that converts the laser light emitted from the light guide 13, into collimated light in the fast axis direction and condenses the laser light on the mirror 15a in the slow axis direction.

Also, reflection films 13c are formed on the upper surface and the lower surface of the light guide 13, respectively. The light source array 11 is placed close to the incident surface of the light guide 13 such that the laser light emitted from each laser light source 11a is incident on the light guide 13 without leaving any excess light in the fast axis direction. An antireflection film may be formed on the incident surface of the light guide 13. The other configuration is the same as that of the above embodiment.

<Effects of Modification 4>

In Modification 4 as well, as in the above embodiment, the line beam B10 that is long in the X-axis direction is generated by the actions of the light guide 13 and the other optical elements. In addition, the laser light is mixed by repeated reflection on the surfaces 13a and 13b of the light guide 13, whereby the intensity of the laser light emitted from the light guide 13 is made uniform in the slow axis direction. Therefore, as in the above embodiment, widening the angle of the line beam B10 and making the radiation intensity distribution of the line beam B10 uniform can be simultaneously achieved even in the case where the number of laser light sources 11a to be arranged is small.

In the configuration in FIG. 11A and FIG. 11B, the spread angle of the laser light incident on the light guide 13 is large in the fast axis direction, so that the laser light may be incident on the upper and lower surfaces of the light guide 13 at an angle exceeding the critical angle and may leak from the upper and lower surfaces to the outside. Meanwhile, in the configuration in FIG. 11A and FIG. 11B, since the reflection films are formed on the upper surface and the lower surface of the light guide 13, the laser light incident on the light guide 13 is inhibited from leaking from the upper surface and the lower surface of the light guide 13 in the fast axis direction in which the spread angle thereof is large. Therefore, the line beam B10 having high radiation energy can be generated without impairing the utilization efficiency of the laser light emitted from each laser light source 11a.

<Modification 5>

In the above embodiment and Modifications 1 to 4, the laser light emitted from each laser light source 11a spreads in the slow axis direction and is incident on the light guide 13 as it is. However, the spread angle of the laser light may be further widened in the long side direction of the line beam B10, and the laser light may be caused to be incident on the light guide 13.

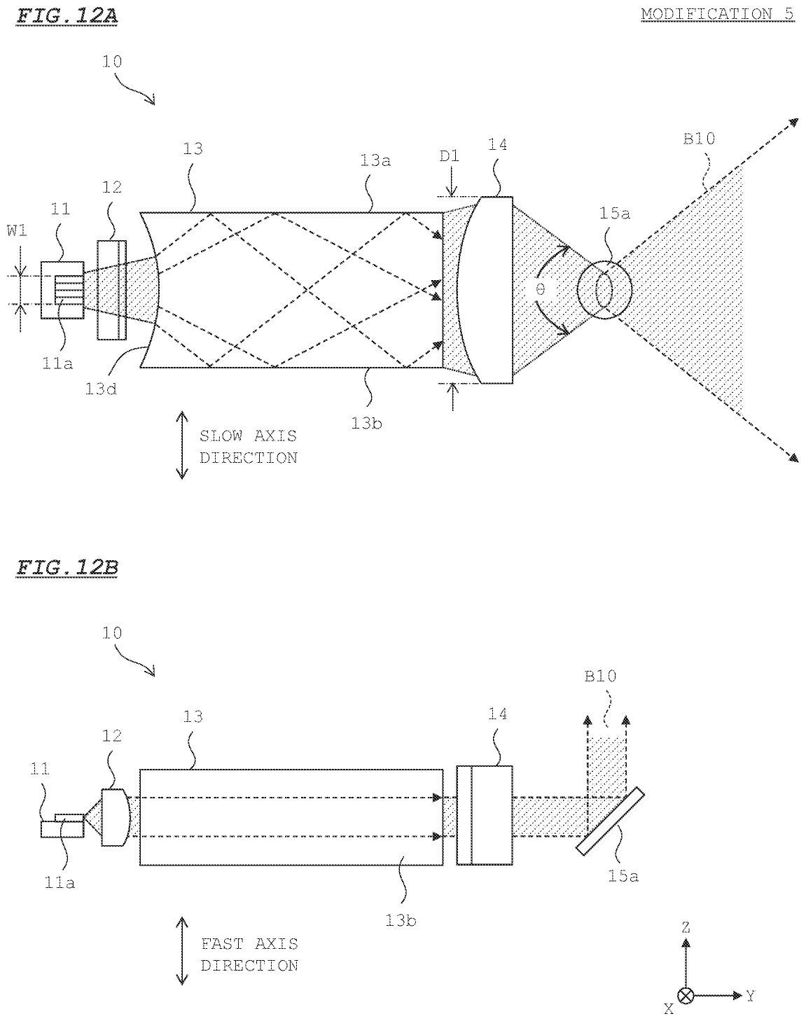

FIG. 12A and FIG. 12B are respectively a plan view and a side view showing a configuration of a line beam scanning optical system 10 according to Modification 5. As in FIG. 6A, for convenience, FIG. 12A shows a state where the optical system from the light source array 11 to the diffusion optical element 16 is developed on one plane.

The line beam scanning optical system 10 in FIG. 12A and FIG. 12B further includes a concave cylindrical surface 13d which further widens the spread angle of the laser light incident on the light guide 13, in the long side direction of the line beam B10. Here, the concave cylindrical surface 13d is formed on the entire incident surface of the light guide 13.

The concave cylindrical surface 13d may not necessarily be formed on the entire incident surface of the light guide 13, and may be formed on a part of the incident surface that covers the range where the laser light is incident. In addition, the concave cylindrical surface may not necessarily be formed on the incident surface of the light guide 13, and a cylindrical lens having a concave cylindrical surface may be additionally placed between the fast axis cylindrical lens 12 and the light guide 13.

The concave cylindrical surface 13d has a curvature only in the slow axis direction. The concave cylindrical surface 13d widens the spread angle of the laser light incident on the light guide 13, such that the total reflection efficiency at the two surfaces 13a and 13b which oppose each other is impaired. Accordingly, the number of reflections of the laser light by the two surfaces 13a and 13b can be increased.

<Effects of Modification 5>

Since the divergence angle of the light is narrow in the slow axis direction of the laser light source 11a, the length of the optical path of the light has to be made longer in order to make the distribution of the light uniform at the light guide 13. On the other hand, in the configuration in FIG. 12A and FIG. 12B, since the spread angle of the laser light incident on the light guide 13 is widened by the action of the concave cylindrical surface 13d provided on the incident surface, it is made possible to efficiently mix the laser light with a shorter optical path length, and the effect of making the light uniform can be enhanced. In addition, the light guide 13 can be downsized and the optical system can be downsized. In each of the configurations of Modifications 1 to 4 as well, similarly, a concave cylindrical surface may be further provided.

<Other Modifications>

In the above embodiment and each modification, the light guide having a rectangular parallelepiped or prism shape with an interior filled with a light-transmitting material is used. However, the light guide may not necessarily have this structure, and may have, for example, a frame-like or hollow structure having surfaces 13a and 13b opposing each other. That is, it is sufficient that the light guide has two surfaces, opposing each other, for confining the laser light at least in the long side direction of the line beam B10, and another surface for bending the optical path of the laser light in the short side direction of the line beam B10. In addition, these surfaces may not necessarily be integrally formed in one member, and may be individually set by members independent of each other.

In the above embodiment and each modification, the two surfaces opposing each other are parallel to each other. However, these two surfaces may not necessarily be parallel to each other. That is, these two surfaces may be titled from a state where the two surfaces are parallel to each other, as long as, while the beam width of the laser light incident on the slow axis cylindrical lens 14 or the lens 17 is widened in the long side direction, the intensity distribution of the laser light in the long side direction can be made uniform by mixing the laser light.

In Modifications 1 and 2 above, two other surfaces for bending the optical path of the laser light are provided to the light guide, and in Modification 3 above, one such other surface is provided to the light guide. However, the number of other surfaces, that is, the number of times the optical path of the laser light is bent, is not limited to these numbers. For example, three or more other surfaces may be provided to the light guide, and the optical path of the laser light may be bent inside the light guide three or more times.

In the above embodiment and each modification, the plurality of laser light sources 11a are arranged such that the slow axes thereof are directed in the long side direction of the line beam B10. However, the method for arranging the laser light sources is not limited thereto. For example, a plurality of laser light sources may be arranged so as to be aligned in a straight line such that the fast axes thereof are directed in the long side direction of the line beam B10, and laser light therefrom may be converted into collimated light in the slow axis direction by a cylindrical lens placed immediately before the light guide. However, in this case, the laser light spreads inside the light guide at a large spread angle in the fast axis direction, and thus may be incident on the two surfaces opposing each other, at an angle exceeding the critical angle. Therefore, in this case, it is preferable to form reflection films on the two surfaces opposing each other to prevent the laser light from leaking from these surfaces to the outside.

In the above embodiment and each modification, the four laser light sources 11a are arranged in a straight line. However, the number of laser light sources to be arranged is not limited thereto, and, for example, only one laser light source may be placed in the line beam scanning optical system 10. In addition, the plurality of laser light sources 11a may not necessarily be unitized, and a plurality of laser light sources may be individually placed. Moreover, the laser light sources 11a may be aligned in a plurality of rows.

In the above embodiment and each modification, the diffusion optical element 16 is placed at the stage subsequent to the light deflector 15, but the diffusion optical element 16 may be omitted. However, from the viewpoint of eye safety, it is preferable that the diffusion optical element 16 is placed as described above. In addition, the diffusion optical element 16 also has an action of making the intensity distribution of the line beam whose intensity distribution is made uniform in the long side direction by the light guide, further uniform in the long side direction by diffusion. Therefore, from this viewpoint as well, it is preferable that the diffusion optical element 16 is placed in the line beam scanning optical system 10. The shape and structure of the diffusion optical element is not limited to that shown in the embodiment, and the diffusion optical element may have, for example, a flat plate shape.

In the above embodiment, an end face-emitting laser diode is used as each laser light source 11a. However, a light source array 11 in which surface-emitting laser light sources such as VCSELs (vertical cavity surface emitting lasers) are aligned in a straight line may be used.

In the above embodiment, as shown in FIG. 5, scanning is performed in the vertical direction with the line beam B10 that is long in the horizontal direction. However, scanning may be performed in the horizontal direction with a line beam that is long in the vertical direction. In this configuration, the spread angle in the long side direction of the line beam B10 can be smaller, but the swing angle in the horizontal direction of the line beam B10 becomes larger.

In the above embodiment, a MEMS mirror is used as the light deflector 15. However, another light deflector such as a magnetically movable mirror or a galvano mirror may be used as the light deflector 15.

The layout of the line beam scanning optical system 10 is not limited to those shown in the above embodiment and each modification. In addition, each of the fast axis cylindrical lens 12, the slow axis cylindrical lens 14, and the lens 17 may not necessarily be a single lens, and may be composed of a combination of a plurality of lenses.

In the above embodiment, the laser radar 1 is mounted on the vehicle 200. However, the laser radar 1 may be mounted on another moving body. In addition, the laser radar 1 may be mounted on equipment or a facility other than the moving body. Moreover, the laser radar 1 may have only an object detection function.

In addition to the above, various modifications can be made as appropriate to the embodiment of the present invention, without departing from the scope of the technological idea defined by the claims.

What is claimed is:

1. A line beam scanning optical system for generating a line beam that is long in one direction and performing scanning with the line beam in a short side direction of the line beam, the line beam scanning optical system comprising:
at least one laser light source;
a light deflector having a mirror configured to deflect the line beam in the short side direction;
a lens configured to condense laser light emitted from the laser light source, at least in a long side direction of the line beam, and cause the laser light to be incident on the mirror; and
a light guide that is placed between the laser light source and the lens and on which the laser light emitted from the laser light source is incident, wherein
the light guide has two surfaces opposing each other in the long side direction of the line beam, reflects the laser light at the two surfaces to confine the laser light inside the light guide, and causes the mixed laser light to be incident on the lens.

2. The line beam scanning optical system according to claim 1, wherein
the lens condenses the laser light only in the long side direction of the line beam,
the line beam scanning optical system further comprises another lens configured to convert the laser light emitted from the laser light source, into collimated light in the short side direction of the line beam, and
the light guide is placed between the lens and the other lens.

3. The line beam scanning optical system according to claim 1, wherein the light guide has another surface configured to bend an optical path in the short side direction of the line beam.

4. The line beam scanning optical system according to claim 3, wherein the light guide has a prism in which the two surfaces and the other surface are integrally formed.

5. The line beam scanning optical system according to claim 3, wherein a reflection film is formed on the other surface.

6. The line beam scanning optical system according to claim 1, wherein
the laser light source is placed such that a slow axis direction thereof is parallel to the long side direction of the line beam, and
the laser light is incident on the two surfaces at an incidence angle that satisfies a total reflection condition.

7. The line beam scanning optical system according to claim 1, wherein the light guide is divided into a plurality of parts along an optical path of the laser light.

8. The line beam scanning optical system according to claim 1, wherein
a plurality of the laser light sources are arranged so as to be aligned in the long side direction of the line beam, and
a width of the light guide in the long side direction of the line beam is larger than a width over which the plurality of the laser light sources are aligned.

9. The line beam scanning optical system according to claim 1, wherein, in the long side direction of the line beam, an effective diameter of the lens is larger than a width of an emission surface of the light guide.

10. The line beam scanning optical system according to claim 1, further comprising a concave cylindrical surface configured to widen a spread angle of the laser light incident on the light guide, in the long side direction of the line beam.

11. A laser radar comprising:
a line beam scanning optical system configured to generate a line beam that is long in one direction and to perform scanning with the line beam in a short side direction of the line beam; and
a light receiving optical system configured to receive reflected light, from an object, of laser light projected from the line beam scanning optical system, wherein
the line beam scanning optical system includes
at least one laser light source,
a light deflector having a mirror configured to deflect the line beam in the short side direction,
a lens configured to condense laser light emitted from the laser light source, at least in a long side direction of the line beam, and cause the laser light to be incident on the mirror, and
a light guide that is placed between the laser light source and the lens and on which the laser light emitted from the laser light source is incident, and
the light guide has two surfaces opposing each other in the long side direction of the line beam, reflects the laser light at the two surfaces to confine the laser light inside the light guide, and causes the mixed laser light to be incident on the lens.

12. The laser radar according to claim 11, wherein
the lens condenses the laser light only in the long side direction of the line beam,
the line beam scanning optical system further comprises another lens configured to convert the laser light emitted from the laser light source, into collimated light in the short side direction of the line beam, and
the light guide is placed between the lens and the other lens.

13. The laser radar according to claim 11, wherein the light guide has another surface configured to bend an optical path in the short side direction of the line beam.

14. The laser radar according to claim 13, wherein the light guide has a prism in which the two surfaces and the other surface are integrally formed.

15. The laser radar according to claim 13, wherein a reflection film is formed on the other surface.

16. The laser radar according to claim 11, wherein
the laser light source is placed such that a slow axis direction thereof is parallel to the long side direction of the line beam, and
the laser light is incident on the two surfaces at an incidence angle that satisfies a total reflection condition.

17. The laser radar according to claim 11, wherein the light guide is divided into a plurality of parts along an optical path of the laser light.

18. The laser radar according to claim 11, wherein
a plurality of the laser light sources are arranged so as to be aligned in the long side direction of the line beam, and
a width of the light guide in the long side direction of the line beam is larger than a width over which the plurality of the laser light sources are aligned.

19. The laser radar according to claim 11, wherein, in the long side direction of the line beam, an effective diameter of the lens is larger than a width of an emission surface of the light guide.

20. The laser radar according to claim 11, wherein, the line beam scanning optical system further comprising a concave cylindrical surface configured to widen a spread angle of the laser light incident on the light guide, in the long side direction of the line beam.
